(19) United States
(12) Patent Application Publication
(10) Pub. No.: US 2002/0100180 A1
(43) Pub. Date: Aug. 1, 2002

(54) Template for use in construction industry

(76) Inventor: Vincent Montefusco, Mammoth Lakes, CA (US)

Correspondence Address: Irving Keschner, Suite 1150, 21515 Hawthorne Boulevard, Torrance, CA, 90503, US

(21) Appl. No.: 09/770,744

(22) Filed: Jan. 26, 2001

(51) Int. Cl. B43L 13/00

(52) U.S. Cl. 33/563; 33/404

(57) ABSTRACT

A multi-function template for use in the construction industry and includes a portion for marking and measuring molding such that the molding can be installed around a bull nose corner. The template preferably comprises a thin, flat, flexible and clear piece of plastic material. The template is capable of sitting flat on any molding surface or the moldings can rest on the template for marking enabling the moldings to be positioned in place for marking and cutting to ascertain if all the pieces align properly. The template also includes 22 ½, 45 and 90 degree edges for marking various materials, a ruler edge and various sized holes for marking drilling positions. A pair of slits are formed in the template adjacent the bull nose enabling the top of the moldings to be marked.

### BACKGROUND OF THE INVENTION

1. Field of the Invention

The present invention provides a tool for use in the construction industry and, in particular, an improved template for forming molding to fit around bull nose corners.

2. Description of the Prior Art

U.S. Pat. No. 5,749,154 to Scharf describes a bull nose corner marking device that allows rapid marking and measuring of wall locations forming an outside bull nose corner where molding pieces are to be secured. Although the Scharf device is lightweight, inexpensive and easy to use, there are a number of disadvantages associated therewith. In particular, the moldings can not be positioned on the Scharf device for marking; only 90 degree corners can be measured and the device can only be placed on top of the molding for measuring, limiting the ability to ascertain whether all the cut pieces are aligned properly, and the device can not measure moldings simultaneously for small rectangular bullnose columns that are close to each other.

What is thus desired is to provide a construction industry device that is simple, lightweight and that is adopted for use in forming molding around bull nose corners.

### SUMMARY OF THE PRESENT INVENTION

The present invention provides a multi-function template for use in the construction industry and includes a portion for marking and measuring molding such that the molding can be installed around a bull nose corner.

The template preferably comprises a thin, flat, flexible and clear piece of plastic material. The template is capable of sitting flat on any molding surface or the moldings can rest on the template for marking, enabling the moldings to be positioned in place for marking and cutting to ascertain if all the pieces align properly. The template also includes 22 ½, 45 and 90 degree edges for marking various materials, a ruler edge and various sized holes for marking drilling positions. A pair of slits are formed in the template adjacent the bull nose enabling the top of the moldings to be marked.

The present invention thus provides a simple, lightweight and relatively inexpensive template which has multiple uses in the construction industry, particularly in shaping molding to fit bull nose round corners.

### DESCRIPTION OF THE DRAWINGS

For better understanding of the present invention as well as other objects and further features thereof, reference is made to the following description which is to be read in conjunction with the accompanying drawing therein:

FIG. 1 is a top view of the template of the present invention;

FIG. 2 is a side view of the template shown in FIG. 1; and

FIGS. 3-8 illustrate the steps utilized for fabricating moldings including the fabrication of a bull nose corner end utilizing the template of the present invention.

### DESCRIPTION OF THE INVENTION

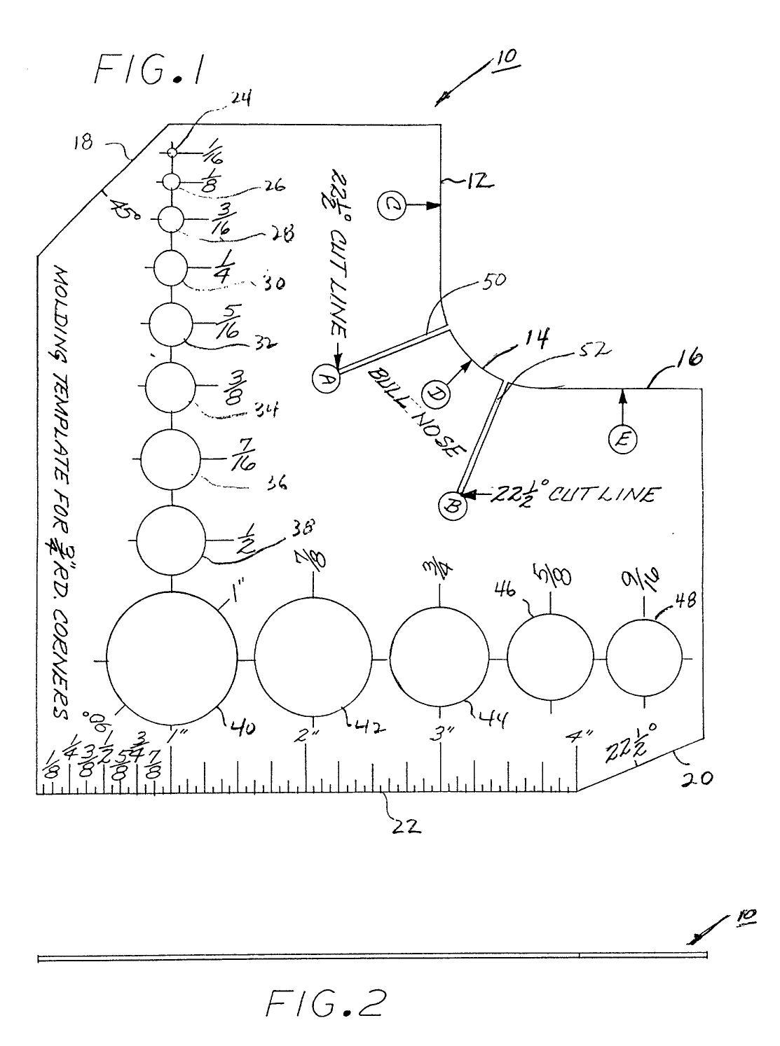

Referring now to FIGS. 1 and 2, the template 10 of the present invention is illustrated. Template 10 is thin and is preferably fabricated from a flexible, translucent material, such as plastic. Template 10 comprises edges 12, 14 and 16 which, as will be set forth in more detail hereinafter, accurately measure moldings for cutting and installing around standard, outside bull nose round corners, such as corners having a ¾ inch radius. Template 10 also includes other features helpful for measuring tasks normally encountered during construction. In particular, edge 18 provides a 450 reference line, edge 20 provides a 22½%° reference line, edge 22 which provides a straight edge ruler function and apertures, or holes, 24, 26 . . . 48 which enable circles of various diameters to be scribed on a workpiece. Template 10 also includes 22½%° cut lines 50 and 52 as illustrated, the function of which will be set forth hereinafter.

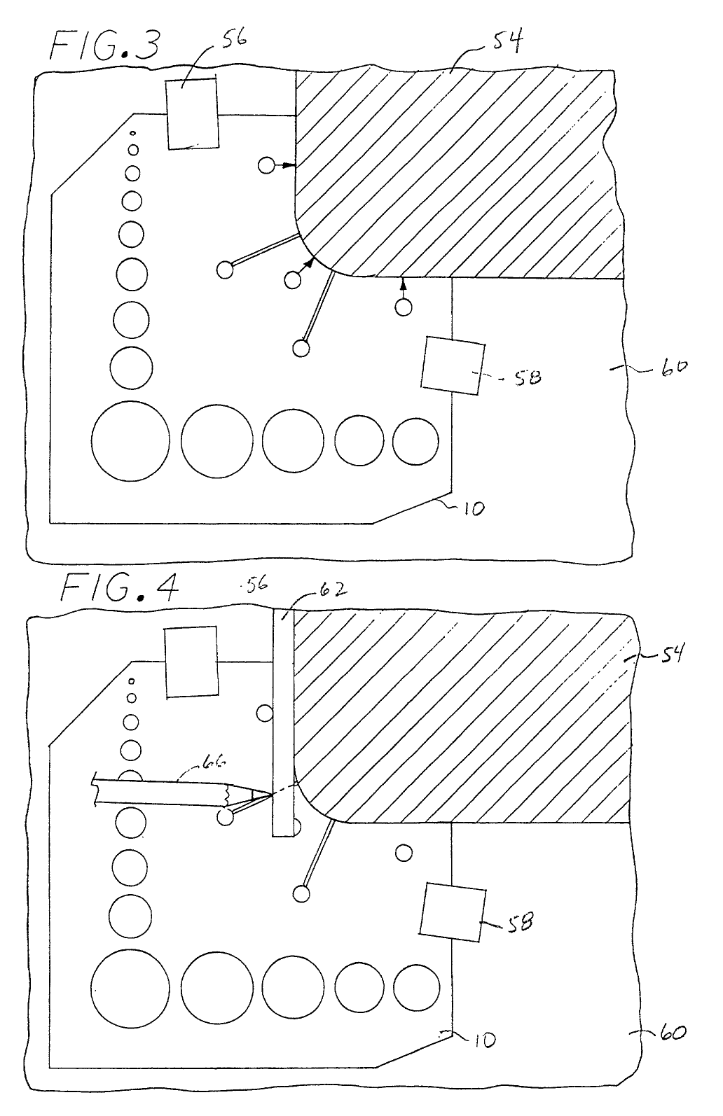

Referring now to FIG. 3, template 10 is shown positioned so the guide edges 12, 14 and 16 are in contact with wall 54. Once template 10 is properly positioned, adhesive strips 56 and 58 secure template 10 to surface 60.

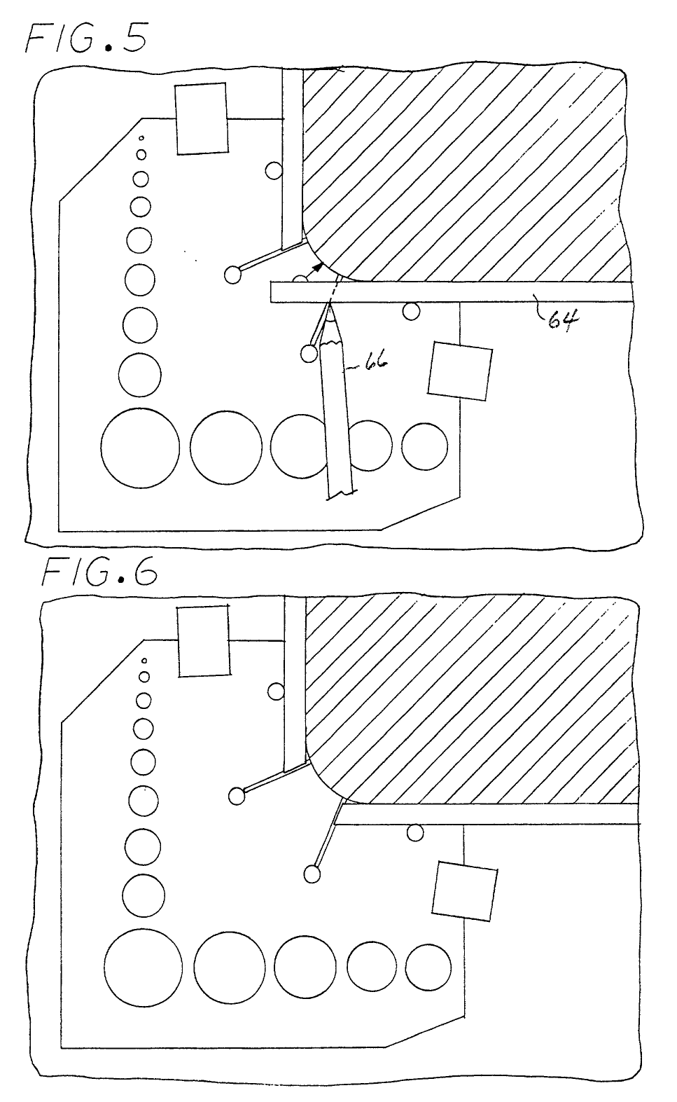

Referring now to FIGS. 4 and 5, moldings 62 and 64 are placed against guide marks 12 and 50, and 16 and 52, respectively, and flush against wall 54.

Moldings 62 and 64 are preferably positioned slightly beyond cut lines 50 and 52, respectively, as illustrated. Moldings 62 and 64 are firmly held against wall 54 and instrument 66, such as a pencil, is used to place marks on the bottom edges of each molding along guide lines 50 and 52. It should be noted that when template 10 is resting flat on top of the moldings, a mark can easily be scribed on top of the molding through the guide lines 50 and 52; when template 10 rests flat on a surface, such as a floor or countertop, the moldings are placed on top of template 10 and a mark is transferred from the 22½%° template cut line 20 to the molding. In either case, after the moldings are marked, the user cuts the molding on the transferred guide marks.

As shown in FIG. 6, moldings 62 and 64 are cut along the guide lines 50 and 52.

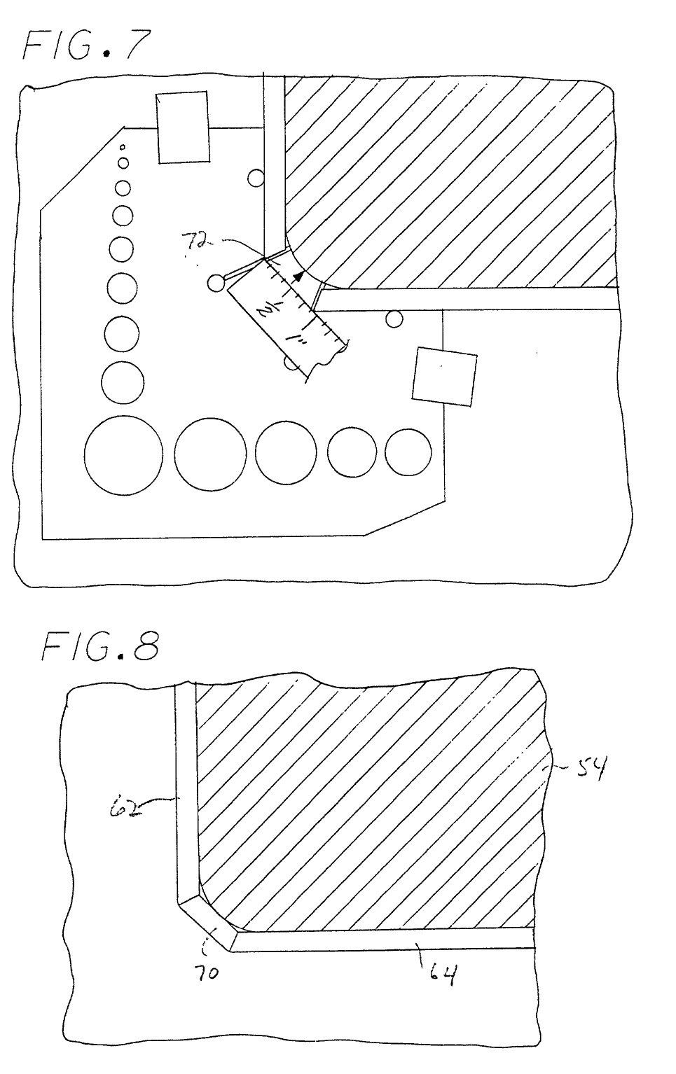

Referring now to FIG. 7, after moldings 62 and 64 are cut, they are positioned on the outside corner against wall 54 to ensure that the angles cuts are aligned with the cut lines 50 and 52. The moldings then are temporarily held in place by tape. The distance between the bottom edges of wall moldings 62 and 64 are measured to provide the dimension for the small corner molding piece 70. Molding piece 70 is then cut at lines 50 and 52 by placing the template 10 over the molding; the cut molding piece 70 is then placed in opening 72 to check that the fit is accurate.

The tape is then removed from wall moldings 62 and 64 and template 10 is removed from surface 60. The molding pieces 62, 64 and 70 are then checked for a snug fit, and larger moldings 62 and 64 are then nailed in place; molding 70 is preferably glued in place. After the glue is dried, the shape cut edges are sanded to provide an aesthetic finished look.

The present invention thus provides a template for use in the construction industry which allows the molding to rest on the template for marking. When the template rests on the molding, the transparent nature of the template enables the moldings to be positioned in place for marking and cutting and to see if the molding pieces align properly. The template also includes a ruler and multiple sized holes for marking drilling positions, and is adaptable for use on various shaped moldings. The template is flexible, thin, and pocket size, the flexibility of template 10 enabling the user to place it in his/her pocket, the template being able to flex or bend as the user moves. The flexibility and thinness of the template enables it to be stored easily in a tool pouch, for example.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A template for fabricating molding to fit around bull nose corners comprising a first guide edge, a second guide edge, a third guide edge having a shape corresponding to an outside bull nose corner and positioned between said first and second guide edges, a first angled cut line interposed between said first guide edge and said third guide edge and a second angled cut line interposed between said second guide edge and said third guide edge.

2. The template of claim 1 wherein said template has one edge adapted for use as a ruler.

3. The template of claim 2 wherein said template has a plurality of holes of different sizes formed therein.

4. The template of claim 1 wherein said template is made of flexible material.

5. The template of claim 4 wherein said material is translucent.
